(19) United States
(12) Patent Application Publication
(10) Pub. No.: US 2008/0084702 A1
(43) Pub. Date: Apr. 10, 2008

(54) Decorative Light String

(76) Inventor: Tung Fong Cheung, Hong Kong (CN)

Correspondence Address: GLOBAL IP SERVICES, 7285 W. Eagle Court, Winton, CA, 95388, US

(21) Appl. No.: 11/608,916

(22) Filed: Dec. 11, 2006

(30) Foreign Application Priority Data
Oct. 10, 2006 (CN) 200620015195.8

(51) Int. Cl. F21V 21/00

(52) U.S. Cl. 362/391; 362/249; 362/351

(57) ABSTRACT

The present invention provides a decorative light string that comprises one or more branch circuits, each of said more branch circuits is parallelly connected each other, and then connected to a common power supply wire for importing operational voltage; each said branch circuit comprises a plurality of light groups, and said plurality of light groups are serially connected in turn; each of said plurality of light groups comprises a first LED, and further comprises a protective diode parallelly connected with said first LED in a reverse direction. Said protective diode may be a rectifier diode, a zener diode, a switching diode or a second LED. In the present invention, the protective diode is parallelly connected with the first LED in the reverse direction via a welding manner and shares a pair of pins with the first LED. Further, the chip of the protective diode and the chip of the first LED may be installed into one housing to form an integrative component, thus the connecting wires are saved. The decorative light string of the present invention has the advantage of more economical, more reliable in performance, more long life-span.

### CROSS REFERENCE TO RELATED PATENT APPLICATION

This patent application claims the priority benefit of a Chinese patent application No. 200620015195.8 filed on Oct. 10, 2006.

### FIELD OF THE INVENTION

The present invention relates to decorative light, and more particularly, to a bunchily connected LED decorative light string.

### BACKGROUND OF THE INVENTION

In celebration days of Spring Festival, Christmas day and so on, people hang generally various decorative light strings to decorate a room, an aisle, Christmas trees and so on, in which the more often used is a bunchy LED decorative light string.

A LED decorative light string in the prior art is shown in FIG. 1, wherein each of the LEDs is simply connected in parallel between each other, and it is connected to an operational power supply. As a result of parallel connection between each LED, the failure of any one of LEDs will not affect the operation of the other LEDs. However, since the operating voltage of the LEDs is lower, the LED decorative light string in such connecting relation may not be directly connected to AC power supply, and then a corresponding step-down transformer is required, such that the cost of the whole production would be increased. Further, when inputted with a higher reverse voltage (e.g., connection error or Electrostatic Discharge (ESD)), the LEDs in the light string circuit will be damaged.

Another LED decorative light string in the prior art is shown in FIG. 2, wherein each of LEDs is generally simple connected in series, then the LED decorative light string is connected to an operational power supply (generally is AC power supply). One disadvantage of such decorative light string is that the whole decorative light string cannot work again when anyone LED is in failure, thereby its reliability is rather poor and its life-span is shorter. When using an AC power supply as the operational power supply, noise current may occur due to natural characters of the LEDs. As shown in FIG. 3, the noise current may cause a disadvantageous affect to the quality of the AC power supply.

### SUMMARY OF THE INVENTION

Aiming at the above-mentioned disadvantages, the question that the reliability of the conventional decorative light string which is simply connected in series is rather poor and its life-span is shorter, and the question that the cost of existing decorative light string which is simply connected in parallel is rather high, both will be solved.

To resolve the technical problem mentioned above. The present invention provides a decorative light string that comprises one or more branch circuits, each of said branch circuits is parallelly connected each other, and then connected to a common power supply wire for importing operational voltage; each said branch circuit comprises a plurality of light groups, and said plurality of light groups are serially connected in turn; each of said plurality of light groups comprises a first LED, and further comprises a protective diode parallelly connected with said first LED in a reverse direction.

In each light group of the present invention, said protective diode is connected with said first LED in a reverse direction via welding manner, and shares a same pair of pins with said first LED. Alternatively, the protective diode may be welded on a Printed Circuit Board (PCB). Then the Printed Circuit Board is connected with the first LED in a reverse direction, and shares a same pair of pins with the first LED. Further, the protective diode may be arranged in a same LED housing with the first LED to form an integrative component.

In the present invention, said protective diode maybe a rectifier diode, a zener diode, a switching diode or a second LED, which is matched with said first LED.

In the present invention, corresponding to said welding manner or said inserting manner of the Printed Circuit Board, said protective diode may be coated with a light-shading material to prevent light from emitting when said protective diode is a second LED.

In the present invention, each branch circuit can be arranged in turn along the same direction; each light group within the same branch circuit is arranged in turn along the same direction; each LED within the same light group is arranged in turn along the same direction, thus making the effect that each LED is connected in turn on the external structure. Further, the LEDs arranged in turn and its connecting wire may be installed in a transparent pipe.

In the present invention, a current limiting resistor utilized to limit the current may be serially connected into each of said branch circuits.

After adopting the technical solution of the present invention, each light group has a protective diode parallelly connected in a reverse direction, corresponding to the first LED, to prevent the LED from being damaged by a reverse high voltage, such as Electrostatic Discharge. Moreover, the total operational voltage of the suitable quantity of light groups that are connected in series is just equal to AC voltage in commercial power because each light group is connected in series, such that a step-down transformer is not required. Each LED is connected one by one in turn from the external structure of view that is similar to the external structure of a conventional LED decorative light string. It is obvious that the LED decorative light string of the present invention have the advantage of more reliable in performance, more long life-span when compared with a conventional LED decorative light string.

### BRIEF DESCRIPTION OF THE DRAWINGS

The present invention will be further explained from combining with the accompanying drawings and embodiments hereinafter, in the accompanying drawings:

FIG. 1 is a schematic view of the circuit connecting relation of a LED decorative light string in the prior art;

FIG. 2 is a schematic view of the circuit connecting relation of another LED decorative light string in the prior art;

FIG. 3 is a schematic view of the current waveforms of the operating decorative light string shown in FIG. 2;

FIG. 4 is a schematic view of the current waveforms of the operating decorative light string shown in FIG. 5;

FIG. 5 is a schematic view of the circuit connecting relation of a LED decorative light string in accordance with a first embodiment of the present invention;

FIG. 6 is a schematic view of the circuit connecting relation of a LED decorative light string in accordance with a second embodiment of the present invention;

FIG. 7 is a schematic view of the circuit connecting relation of a LED decorative light string in accordance with a third embodiment of the present invention;

FIG. 8 is a schematic view of the circuit connecting relation of a LED decorative light string in accordance with a fourth embodiment of the present invention;

FIG. 9 is a schematic view of the connection configuration of the LED decorative light string shown in FIG. 5, which is formed by separated LEDs;

FIG. 10 is a schematic view of the connection configuration of the LED decorative light string shown in FIG. 5, which is formed by integrative LEDs;

FIG. 11 is a schematic view of the LED decorative light string shown in FIG. 10, which is installed in a transparent pipe.

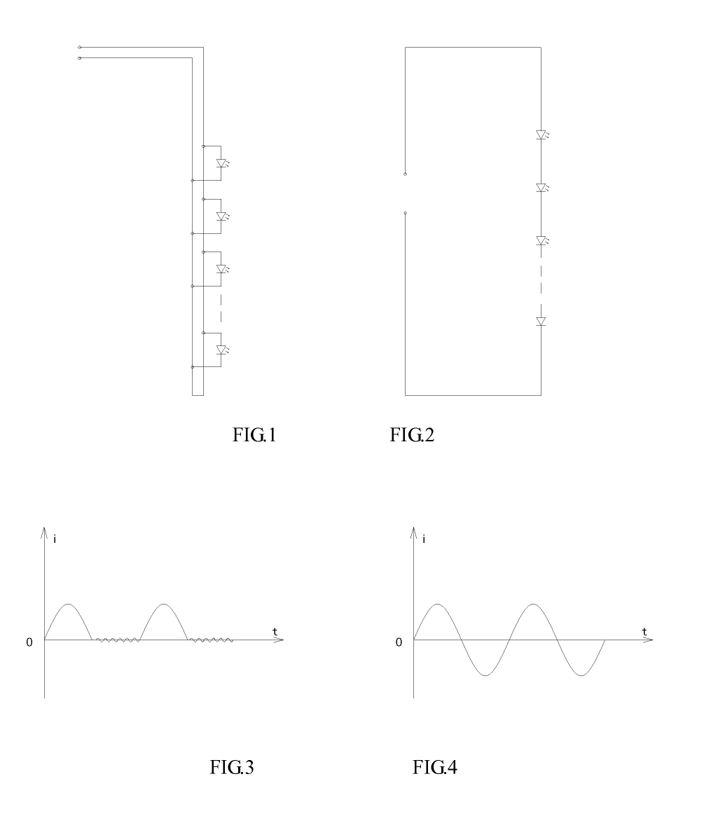

### DETAILED DESCRIPTION OF THE PREFERRED EMBODIMENT

In the first embodiment of the present invention, the circuit connecting relation of a LED decorative light string is shown in FIG. 5. It can be seen from the figure that there comprise a quantity of light groups and the light groups are in turn connected in series; in each light group, there are two LEDs parallelly connected in reverse direction in the circuit, wherein each of the two LEDs is a protective diode of the other one, corresponding to the solution that the first LED and the second LED are matched with each other.

The total operational voltage of the suitable quantity of light groups that are connected in series is just equal to AC voltage in commercial power, such that a step-down transformer is not required. For example, in respect to 220V AC power supply, 73 light groups can be in turn connected in series if the operational voltage of the LED is 3V. On the other hand, because two LEDs in each light group are parallelly connected in reverse direction, thereby only the other LEDs which are connected in the same direction could not normally working when one LED is failure, but the LEDs which are connected in reverse direction could still normally working. Upon the case that more than 70 light groups are connected in series, the chance that two LEDs in the same light group are failure at one time is very small according to statistical probability. Therefore, such LED decorative light string has the advantages of more economical, more reliable in performance, more long in life-span and so on.

On the other hand, because two LEDs are parallelly connected in reverse direction in each light group, when AC power supply is directly connected to the light string, the positive half-period of Sin AC will cause all LEDs that are connected in forward direction thereof lighting, and the negative half-period of Sin AC will cause all LEDs that are connected in reverse direction thereof lighting, i.e. there are LEDs working normally in both the positive and the negative half-period of Sin AC. The current waveform in working is shown in FIG. 4. Compared with the prior art, the decorative light strings of the present embodiment have higher luminous efficiency, and noise current caused from only using half a period may not occur. As shown in FIG. 5, a current limiting resistor R1 is connected in order to prevent an over current. Further, other current limiting resistors may also be used.

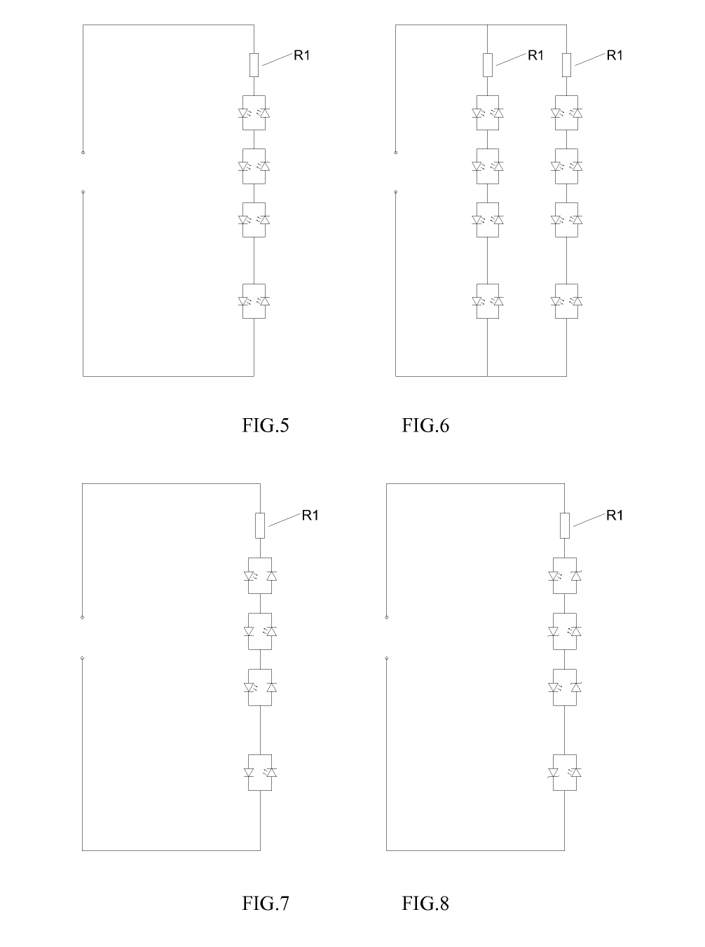

In the second embodiment of the present invention as shown in FIG. 6, a LED light string comprises two branch circuits, wherein each of the two branch circuits is identical with the single branch circuit shown in FIG. 5. More identical or similar branch circuits parallely connected with each other may be used in this embodiment.

In some embodiments, other types of protective diodes may be used, such as a rectifier diode, a zener diode, a switching diode or other LEDs which have the function of prevent reverse puncturing, due to the high cost of the LEDs. In the third embodiment as shown in FIG. 7, a rectifier diode is used as the protective diode. Each light group comprises a LED and a rectifier diode, and these two components are parallelly connected in reverse direction. When implemented, electrically matchable components should be selected to make one of the LED and the rectifier diode to be a corresponding protective component of the other one, thus failure of the light string will be avoided. If only the LED and the rectifier diode in each light group are parallelly connected in the reverse direction, all the LEDs in the light string may be connected in turn along a same polar direction of the circuits, or may be connected randomly. Meanwhile, the total positive voltage should be equal to the total reverse voltage in each of the branch circuits, otherwise magnitude unbalance between the positive current and the reverse current will occur. These will finally cause an uneven brightness of the various light groups. Shown in FIG. 7 is an embodiment that randomly connected. When connected to the AC power supply, if the LEDs in the first and the third light groups work in the positive half-period of the Sin AC, the LEDs in the second and the fourth light groups work in the negative half-period of the Sin AC.

In the embodiment shown in FIG. 8, a zener diode is used as the protective diode. Referring to the FIG. 8, each light group comprises a LED and a zener diode, and these two components are connected parallely in a reverse direction. When implemented, electrically matchable components are required. Similarly, if only the LED and the zener diode in each light group are parallelly connected in the reverse direction, all the LEDs in the light string may be connected in turn along a same polar direction of the circuits, or may be connected randomly. Meanwhile, the reverse voltage of the zener diode is required to be larger than the positive voltage of the LED.

In practice, the above-mentioned rectifier diode, zener diode, switching diode and the second LED may be connected parallely in a reverse direction with the first LED via a welding manner, and may share pins of the first LED. For example, these components may be directly welded with the first LED. Alternatively, the protective diode is firstly welded on a micro circuit board. Then the micro circuit board is installed on the pins of the first LED via an inserting manner. In respect of these two connecting manner, the second LED when used as the protective diode may be coated with a light shading material to prevent light from emitting. For example, LEDs with secondary quality and dim brightness (this kind of LED only can not meet the requirement of brightness, but the electrical property is conformed to the standard) can be utilized as the protective diode to replace the LEDs emitting blue light, green light or white light due to the consideration of cost efficiency, since the cost of these LEDs with secondary quality is even lower than a general rectifier diode. In order prevent these LEDs with secondary quality from impacting the blue light, pure green light or white light effects of the whole product, a black paint may be coated on the surface of these LEDs to avoid emitting light. At this point, the selected LEDs with secondary quality and dim brightness are functioned as a rectifier protective diode.

In the technical solution using a rectifier diode as a protective diode, a chip of the rectifier diode may be arranged in the same diode housing with a chip of the first LED to form an integrative component. Similarly, chips of the two LEDs may be arranged in a single diode housing to form an integrative component when using a second LED as the protective diode.

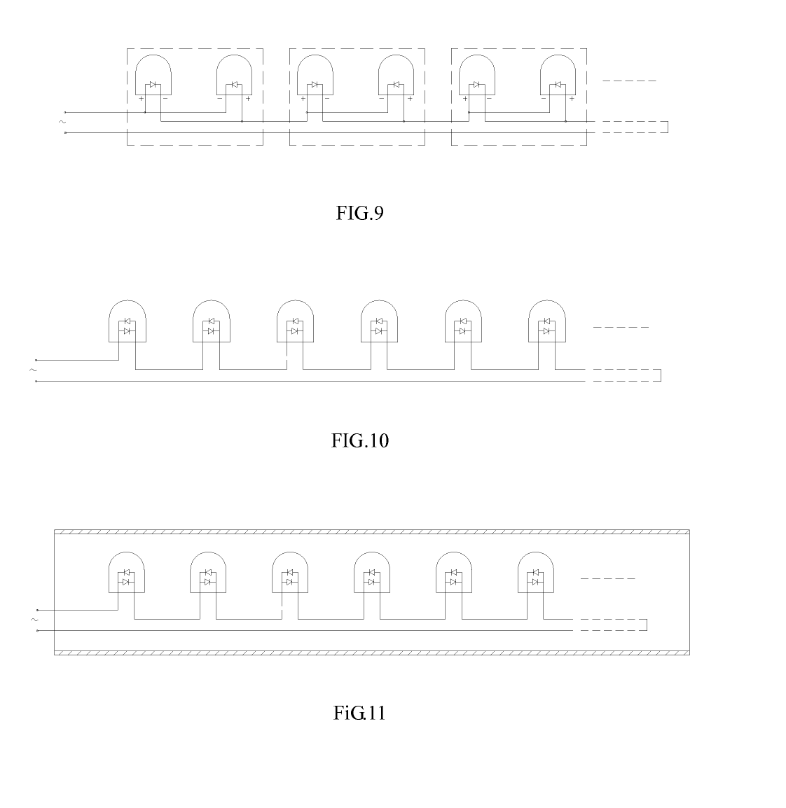

Referring to FIG. 9, when the LED decorative light string in FIG. 5 is formed by separated LEDs, the first and the second LEDs are parallely connected in reverse direction to form one light group; the third and the fourth LEDs are parallelly connected in reverse direction to form another light group; the fifth and the sixth LED are parallelly connected in reverse direction to form further one light group, and the like, the light groups are connected in turn in series. Seeing from the whole external shape, various LEDs are arranged in turn along the conducting wire, similarly to a conventional LED decorative light string. As shown in the figure, one disadvantage of this connection method is that more connecting wires are required. With the price of the copper wire rising, the cost of the product increased.

When utilizing welding manner, and sharing a pair of pins or integrating two LED chips into one housing, one light group will only have a pair of pins, thus saving conducting wires. As shown in FIG. 10, when two LED chips are integrated into one housing, their connections are facilitated, i.e. the integrated components are connected in series to save a large amount of wires. Referring to FIG. 11, the LED decorative light string shown in FIG. 10 can also be installed into a transparent pipe, such as a transparent plastic pipe, thus a variety of shapes can be achieved by bending or knitting such pipe according to a demand.

In other embodiments, each light group may have more LEDs connected, for example, one light group may comprise two LEDs connected in a same direction plus a rectifier diode; one light group may comprise three LEDs connected in a same direction plus a zener diode; or one light group may comprise four LEDs, wherein two LEDs are connected parallelly in one direction, the other two LEDs are connected parallely in a reverse direction.

What is claimed is:

1. A decorative light string, comprising:
one or more branch circuits, parallelly connected with each other for importing operational voltage;
each of said branch circuits comprising a plurality of light groups serially connected in turn;
each of said plurality of light groups comprising a first LED, and a protective diode parallelly connected with said first LED in a reverse direction.

2. The decorative light string according to claim 1, wherein said protective diode connects with said first LED via a welding manner, and shares a same pair of pins with said first LED.

3. The decorative light string according to claim 1, wherein said protective diode is welded on a Printed Circuit Board, which is parallelly connected with said first LED in a reverse direction, and shares a same pair of pins with the first LED.

4. The decorative light string according to claim 1, wherein the chip of said protective diode and the chip of said first LED are installed into a same housing to form an integrative component.

5. The decorative light string according to claim 1, wherein said protective diode may be a rectifier diode, a zener diode, a switching diode or a second LED, which is matched with said first LED.

6. The decorative light string according to claim 2, wherein said protective diode is a second LED coated with a light-shading material for preventing light from emitting.

7. The decorative light string according to claim 3, wherein said protective diode is a second LED coated with a light-shading material to prevent light from emitting.

8. The decorative light string according to claim 5, wherein each of branch circuits is arranged in turn along the same direction; each light group within the same branch circuit is arranged in turn along the same direction; each LED within the same light group is arranged in turn along the same direction, thus making the effect that each LED is connected in turn on the external structure.

9. The decorative light string according to claim 8, wherein the LEDs arranged in turn and its connecting wires are installed in a transparent pipe.

10. The decorative light string according to claim 9, wherein a current limiting resistor for limiting the current is serially connected into each of said branch circuits.
